(19) United States
(12) Patent Application Publication
(10) Pub. No.: US 2004/0020998 A1
(43) Pub. Date: Feb. 5, 2004

(54) Fog generator

(76) Inventor: Helmut Stueble, Spartanburg, SC (US)

Correspondence Address: David M. Sigmon, Dority & Manning, Attorneys at Law, P.A., P.O. Box 1449, Greenville, SC, 29602, US

(21) Appl. No.: 10/210,304

(22) Filed: Aug. 1, 2002

(51) Int. Cl. E01H 13/00; A01G 15/00; F02M 1/00; C10J 1/12; B01D 47/06

(52) U.S. Cl. 239/14.1; 261/115

(57) ABSTRACT

The fog generator is provided for creating a fine mist to moisten a product being processed or an environment in which the product is being processed. The fog generator includes a suction housing and an induction conduit having openings on opposite ends operably disposed to or carried within the suction housing. A nozzle operably disposed at one of the open ends of the induction conduit creates a spray by forming a mixture of carrying medium and droplets of moistening medium. Clean air is induced to mix with the spray to form the mist within the induction conduit. A moistening medium separator within the fog generator separates large droplets of the moistening medium, leaving only a fine mist of micro-droplets to exit the fog generator.

### BACKGROUND OF THE INVENTION

The present invention relates to a device for creating a fog for humidification purposes preferably used in a manufacturing environment. More specifically, the present invention relates to a device of creating a fog to control water content in goods and environments during the manufacturing process.

For many goods, natural and man-made products, a certain water content often improves the ability to process that product in a manufacturing environment as well as decrease the product's static load. Examples of such goods include: hydroscopic fibers and any products from natural sources, synthetic materials, electronic parts (static load reduction), and wood particle products. In the past, manufacturing facilities have tried different methods to increase the water content of such goods with inconsistent degrees of success.

Often, manufacturing facilities use the facilities' air conditioning system to control the humidity within each facility and maintain that humidity at a desired level in an effort to change the water content of the goods which are being processed. The air in these plants is kept near its saturation point, usually between 70% to 90% humidity. Nearly saturated air, however, contains a limited amount of water per cubic feet/minute (cfm) of air flow and has limited capabilities of increasing water content of such goods. The humid air is in effect used to maintain the existing water content in the goods.

The air conditioning systems are expensive to buy, operate, and maintain. A large part of planning and budget for building manufacturing facilities which process such goods goes toward design and installation of the air-conditioning system so that it can maintain a high level of humidity in the facility during operation. In correlation, the yearly expense for maintaining these air-conditioning systems consumes a large percentage of the facilities budget. Further, the high humidity also creates an uncomfortable environment in which to work.

As another method to increase water content of goods, manufacturing facilities use spray nozzles to directly apply water droplets to the room air or to the material being processed. These spray nozzles distribute water droplets into the room air by mixing a combination of compressed air and water or by using water placed under a high pressure. Such spray nozzles, however, tend to produce too many large water droplets, which creates problems with over humidification of the goods. Such over humidification actually decreases the ability to process the goods and can lead to other problems such as mildewing of the goods. Further, wayward droplets that land on the machinery, which, because of their size, do not timely evaporate, cause a build-up of water on machine parts. This excessive water on the machinery often leads to untimely corrosion of machine parts.

The present invention relates to a fog generator that addresses at least some of the drawbacks of conventional humidifying apparatuses and devices used to control humidity in a process area and the water content of goods and materials being processed.

### SUMMARY OF THE INVENTION

Objects and advantages of the invention will be set forth in part in the following description, or may be obvious from the description, or may be learned through practice of the invention.

The fog generator of the present invention creates a fine mist to moisten a product being processed or an environment in which the product is being processed. In a particular embodiment of the present invention, the fog generator includes a suction housing, or a tank, that acts as an external body of the fog generator. An induction conduit operably disposed to or carried within the suction housing possesses openings on opposite ends. A nozzle is operably disposed at one of the open ends of the induction conduit. A supply of a moistening medium and a supply of a carrying medium connect to the nozzle to create a spray of the moistening medium within the fog generator.

The nozzle creates the spray by forming a mixture of carrying medium and droplets of moistening medium. An air filter is disposed to the suction housing for cleaning air that enters into the fog generator, so that clean air can be induced to mix with the spray to form the mist within the induction conduit. A moistening medium separator is operably disposed at an opposite open end of the induction conduit from the nozzle. The moistening medium separator causes excessively large droplets of the moistening medium to be removed from the mist, so that only a fine mist of micro-droplets is released from an outlet conduit of the fog generator, which is integral to the suction housing. The moistening medium separator can take on many forms, including a flat plate, a mesh, fiber fill, a nonwoven material, a pool of moistening medium or even a wall of the suction housing.

In another embodiment of the present invention, the fog generator includes a suction housing, or tank, with a nozzle operably disposed within the suction housing. A supply of a moistening medium that feeds a moistening medium to the fog generator operably connects to the nozzle. The supply of moistening medium can be external or internal to the suction housing. The nozzle creates a spray of the moistening medium fed to the nozzle by the supply of moistening medium. The spray created by the nozzle disperses the moistening medium as droplets within the suction housing. An air filter integral with the suction housing cleans air that enters into the fog generator, so that clean air can be induced to mix with the spray of droplets of moistening medium to form a mist. A moistening medium separator operably disposed within the suction housing opposite the nozzle causes heavier droplets of the moistening medium to be removed from the mist to create a fine mist of micro-droplets. An outlet conduit located on the suction housing releases the fine mist from the fog generator. A drain within the suction housing then removes accumulated moistening medium which is separated from the fine mist.

The invention will be described in greater detail through reference to the attached figures and particular embodiments of the invention.

### BRIEF DESCRIPTION OF THE DRAWINGS

FIG. 1 illustrates a perspective cutaway view of an embodiment of the present invention with an internal supply of a moistening medium;

FIG. 2 illustrates a cutaway view of an embodiment of the present invention with an external supply of a moistening medium;

FIG. 3 illustrates a cutaway view of another embodiment of the present invention with an internal supply of a moistening medium;

FIG. 4 illustrates a cutaway view of another embodiment of the present invention with an external supply of a moistening medium;

FIG. 5 illustrates a cutaway view of a further embodiment of the present invention with an internal supply of a moistening medium;

FIG. 6 illustrates a cutaway view of a further embodiment of the present invention with an external supply of a moistening medium; and

FIG. 7 illustrates a cutaway view of a further embodiment of the present invention with an internal supply of a moistening medium.

### DETAILED DESCRIPTION

Reference will now be made in detail to the presently preferred embodiments of the invention, one or more examples of which are shown in the figures. Each example is provided to explain the invention, and not as a limitation of the invention. In fact, features illustrated or described as part of one embodiment can be used with another embodiment to yield still a further embodiment. It is intended that the present invention cover such modifications and variations.

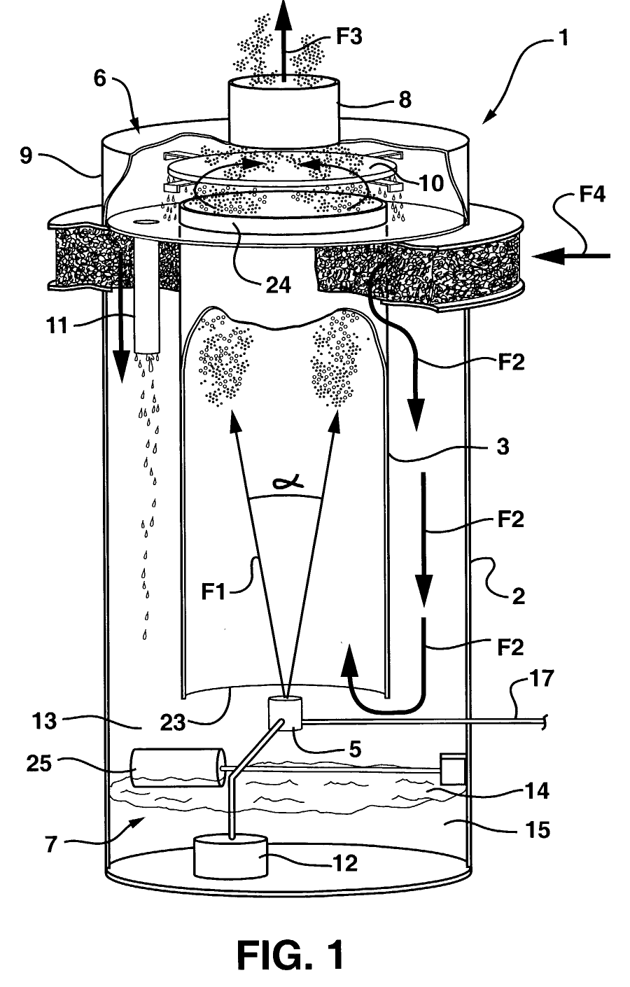

FIG. 1 illustrates a schematic of an embodiment of the invention. A fog generator 1 used to produce a fine mist of micro-droplets F₃ for humidifying a room or a product in process in a manufacturing facility. A carrying medium from a supply of a carrying medium 17 and a moistening medium from a supply of a moistening medium 15 are fed to a nozzle 5 within a suction housing, or tank, 2 of the fog generator 1. The nozzle 5 releases a spray F₁ of a mixture of the carrying medium and droplets of the moistening medium within an induction conduit 3. The induction conduit 3, which may be cylindrical or another geometric shape, forms an opening at opposing ends 23, 24 with the nozzle being positioned at one of the opposing ends 23, 24. The spray F₁ disperses from the nozzle 5 in a conical fashion at a high velocity. The spray F₁ created by the nozzle 5 can be of any dispersion shape, a three-dimensional or flat planar shape. However, it is preferable if the nozzle creates a conical shaped spray. The velocity of the spray F₁ induces air F₄ entering the suction housing 2 through air filter 4 to mix with the spray F₁ in the induction conduit 3 to form a mist. The velocity further causes the newly formed mist to travel into a moistening medium separator 6. The moistening medium separator 6 causes excessively large droplets of the moistening medium to fall out of the mist, thereby allowing a fine mist micro-droplets F₃ of to exit an outlet conduit 8.

In this embodiment, the moistening medium separator includes a container 9 and a flat plate 10. The flat plate 10 is positioned above the opening of the induction conduit 3. The flat plate 10 can be made of any non-corrosive material and preferably possesses a diameter at least as large as the open end 24 of the induction conduit 3. The flat plate 10 causes the mist to travel around it to escape from the fog generator. In so doing, the larger droplets which have a mass that prevents the air within the mist from changing their travel trajectory, collide with the flat plate and thus accumulate in container 9, where excess moistening medium drains back into the suction housing 2 through drain 11. The moistening medium separator can take many forms, whether, for example, it is a flat plate, a mesh, a fiber fill or other nonwoven, or perforated plate within a container, or just a flat plate, mesh, a fiber fill or other nonwoven, perforated plate alone, or even just the wall of the suction housing 2.

Having an outlet conduit 8 with a smaller diameter than the flat plate 10 is often desirable to further insure that only a fine mist of micro-droplets exits the outlet conduit 8.

The excess moistening medium, which is drained from the moistening medium separator, travels to the bottom of the suction housing 2 and replenishes the supply of moistening medium, which is in this cased a pool at the bottom of the suction housing 2. More moistening medium can be added to the suction housing as needed. It may be beneficial to maintain a minimum amount of the medium in the pool at all times. A moistening medium filter 12 draws moistening medium from this pool and into a fluid line 13. Through the fluid line 13, the nozzle 5 is provided with the moistening medium. A float valve 7, which is well known in the art, can be used to control the flow of the moistening medium to the nozzle 5. The float valve as depicted here may include a float 25, which rests on the moistening medium, and a lever 14, which extends from the float 25 to a trip ball 16. As the moistening medium causes the float 25 to rise and fall, the flow to the nozzle is controlled. Other sensing devices such as a water sensor combined with a solenoid or motorized modulating valve can be used to control the flow of the moistening medium.

The spray angle α of the conical shaped spray F₁ can be crucial in providing a proper mist F₃. If the spray angle α along with the velocity of the spray F₁ properly correlate to the length and cross-sectional dimensions of induction conduit, then the air filter will need no other source of air than the surrounding ambient air. Preferably, the spray angle α is between 10° and 45°, for example, angle α may be around 20°. The velocity of the spray F₁ draws ambient air F₄ through the air filter 4, causing the air filter 4 to clean the air F₄. The clean air F₂ is pulled by the spray F₁ through the open end 23 of the induction conduit 3 inducing the clean air F₂ to mix with the spray F₁ to form the mist. The air filter 4 also can take many forms as well as being placed in different locations on or within the fog generator.

The amount of air by volume which is mixed with the spray may vary depending on the desired use of the fine mist. The amount of air by volume can be around 10-50 times greater than the amount of volume of the spray F₁, for example, around 30 times greater. The amount of air by volume can also be greater if the air filter is connected to a supply of air like a fan or an air duct from the facility's air-conditioning system. In such a situation where air is fed from an air duct, the fog generator may not need an air filter attached to it.

The carrying medium will usually be some type of compressed air, while it is preferable to use water as a moistening medium. However, instead of water, other liquids or additives to water such as anti-statics, softeners and oil can be used to achieve desired characteristics in the goods.

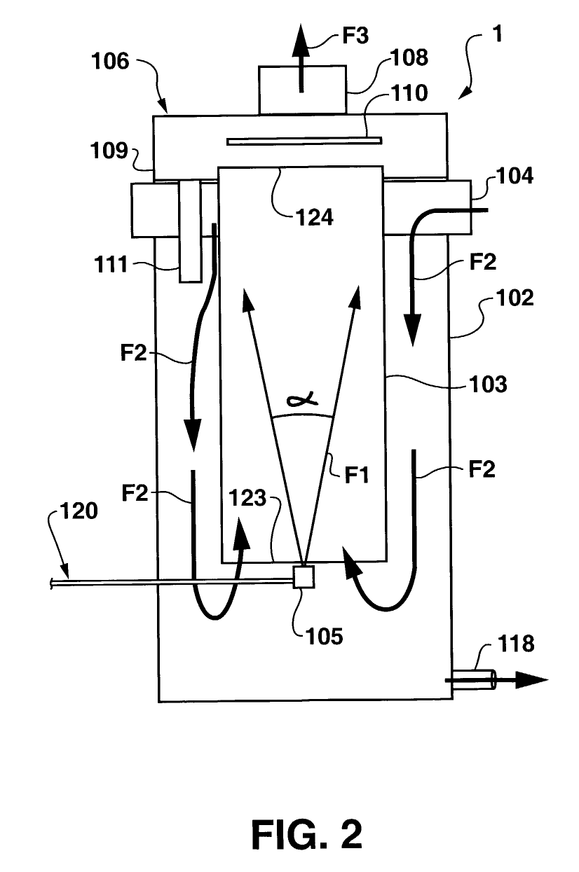

FIG. 2 depicts a different embodiment of a fog generator 1. Instead of providing a carrying medium and a moistening medium to the nozzle, just a supply of moistening medium 120 placed under pressure travels through the nozzle. In general, though, this embodiment works in a similar manner. The nozzle 105 turns the moistening medium under pressure into a conical spray F₁ with a spray angle α. Since the nozzle 105 is placed at lower open end 123 of the induction conduit 103, the spray F₁ travels upward at a high velocity inducing air F₄ to enter the air filter 104 which cleans the air F₄. The clean air F₂ mixes with the droplets of spray F₁ forming a mist, which enters a moistening medium separator 106 of the same construction as illustrated in FIG. 1. The flat plate 110 of moistening medium separator 106 causes the larger droplets to fall out of the mist as described above, leaving only a fine mist of micro-droplets F₃. The fine mist of micro-droplets F₃ then travels out of an outlet conduit 108 into a transfer pipe or duct to be taken to the desired location, or exits straight into the surrounding atmosphere from the outlet conduit 108. The accumulated moistening medium drains out of the moistening medium separator container 109 through drain 111 into the suction housing 102. The moistening medium then drains from the suction housing 102 through suction housing drain, or generated vacuum source 118.

This particular embodiment, which is not as self-contained as the embodiment described in FIG. 1, may be more useful in newly built facilities which take into account this new technology where proper moistening medium lines and drainage can be installed during the building process. The embodiment of FIG. 1, being more self-contained, will most likely be more useful in existing facilities, since all that is really needed is a supply of a carrying medium such as compressed air, which is common in most manufacturing facilities. Therefore, this invention is easily adaptable for both existing as well as future planned facilities.

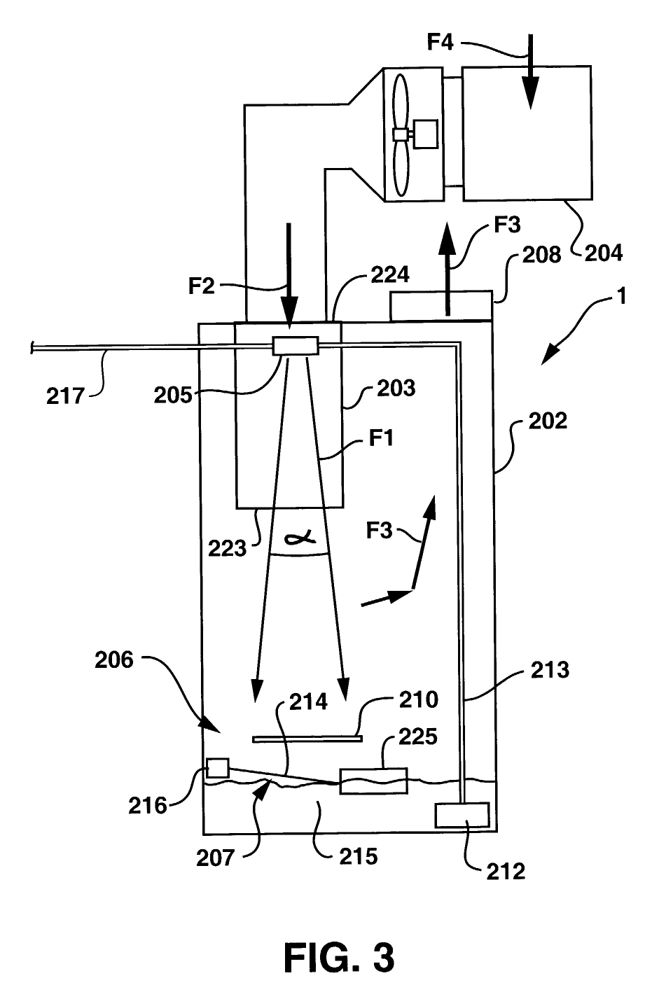

FIG. 3 shows another embodiment with a different construction of a fog generator 1. A nozzle 205 in this embodiment is located at an upper open end 224 of an induction conduit 203 located within a suction housing 202. A fan 240 is operably disposed in front of an air filter 204. The fan 240 is connected to the suction housing 202 by a conduit above the induction conduit 203. This inclusion of a fan is not exclusive to this embodiment and can be a part of any of the embodiments herein described. The fan 240 also can represent the internal air conditioning system as an air duct connected to the fog generator.

As the nozzle 205 creates the spray F₁ with a spray angle α of a mixture of a carrying medium and droplets of a moistening medium from the carrying medium supply 217 and the moistening medium supply 215, the velocity of the spray F₁ pulls clean air F₂ which has traveled through the air filter 204 and the fan 240 into the induction conduit 203 to mix with spray F₁ forming a mist. With the nozzle 205 pointing in a direction away from the outlet conduit 208, the moistening medium separator 206 can take on a more simplified form. In the illustrated embodiment, the placement of a flat plate 210 in front of the lower open end 223 causes the larger droplets of the moistening medium to accumulate on the flat plate 210 and fall to the bottom of the suction housing 202. The micro-droplets of moistening medium and the air forming the fine mist F₃ travel upward towards the outlet conduit 208, while the large droplets travel downward towards the flat plate 210 and the supply of moistening medium 215 which, in this case, is a pool of moistening medium in the bottom of the suction housing 202. The bottom of the suction housing or the pool of moistening medium 215 can also serve as the moistening medium separator 206. This simplified form reduces the added expense of a more complicated moistening medium separator.

As in the embodiment illustrated in FIG. 1, the supply of the moistening medium 215 in FIG. 3 can be controlled by a float valve 207, which includes a float 225, a lever 214 and a trip ball 216. The moistening medium from the supply of moistening medium travels through a filter 212 and into a fluid line 213 on its way to the nozzle 205.

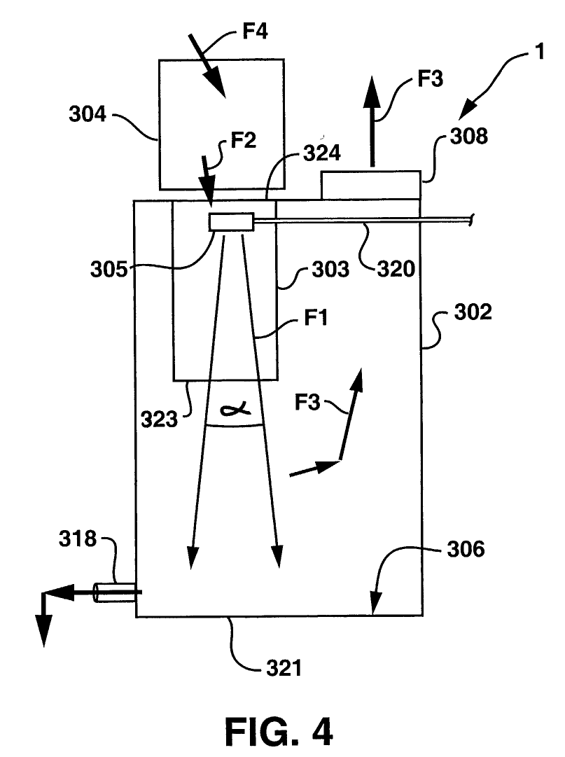

FIG. 4 shows another embodiment with a different construction of a fog generator 1. The nozzle 305 in this embodiment is located at an upper open end 324 of an induction conduit 303. The air filter 304 through which air F₄ travels is disposed to the suction housing 302 directly above the induction conduit 303. In this embodiment, however, the supply of moistening medium 320, which feeds the nozzle 305, is an external source placed under pressure. As the nozzle 305 creates the spray F₁ of droplets of a moistening medium from the moistening medium supply 320, the velocity of the spray F₁ pulls the cleaned air F₂ which has traveled through the air filter 304 into the induction conduit 303 to mix with spray F₁ forming a mist.

As in FIG. 3, with the nozzle 305 in FIG. 4 pointing in a direction away from the outlet conduit 308, the moistening medium separator 306 in this embodiment represents one of its simplest forms. In the illustrated embodiment, as the conical shape spray F₁ with spray angle α exits the lower open end 323 of the induction conduit 303, the larger droplets of the moistening medium as stated above travel generally in a straight line. Therefore, the wall at the bottom of the suction housing 321 acts as the moistening medium separator 306. The micro-droplets of moistening medium and the air forming the fine mist F₃ travel upward towards the outlet conduit 308, while the large droplets travel downward towards bottom wall of the suction housing 321. Since the supply of moistening medium 320 is an external source, the moistening medium, which accumulates in the bottom of the suction housing 302 runs out of the suction housing 302 through a drain 318, or it may be pumped out.

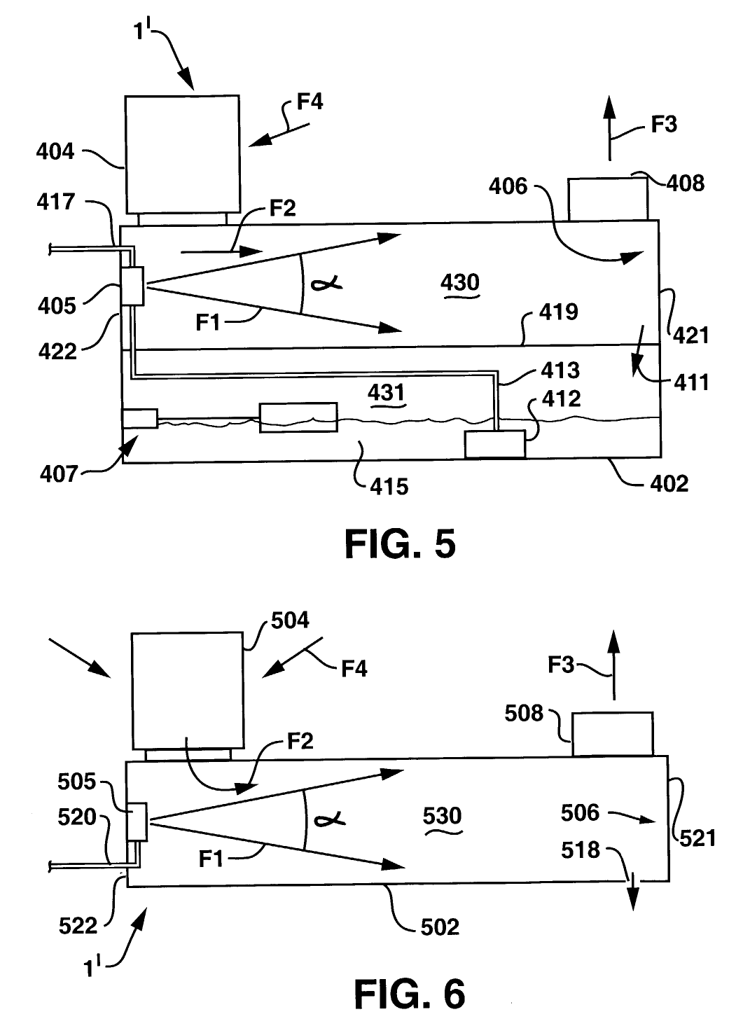

Induction conduits, while they can prove to be conducive for inducing air to mix with the spray, are not always necessary as FIGS. 5 and 6 illustrate. FIG. 5 depicts a further embodiment in which the fog generator 1′ possesses a more horizontal orientation. The fog generator 1′ includes a suction housing 402, which possesses two chambers, 430, 431. The spray chamber 430 resides above the moistening medium chamber 431, and they are separated from one another by divider wall 419. The spray chamber 430 includes two opposing walls 422, 421. The nozzle 405 is disposed within the spray chamber 430 on wall 422.

As described above, the nozzle 405 disperses carrying medium from the carrying medium supply 417 and moistening medium from the moistening medium supply in the form a conical spray F₁ within spray chamber 430. Air F₄ entering through air filter 404 is cleaned and the spray F₁ induces clean air F₂ to mix with it to form a mist of carrying medium, clean air F₂, and droplets of moistening medium. The heavier moistening medium droplets travel generally straight toward the wall 421 of the spray chamber 430, while clean air F₂ and the micro-droplets of the moistening medium travel out of the outlet conduit 408 in the form of a fine mist F₃. Since as above the outlet conduit 408 is not located directly in front of the spray F₁, a simple moistening medium separator 406, the wall 421, causes the heavier droplets to accumulate and then flow out of the spray chamber 430 through drain 411.

The excess moistening medium flows into a pool of moistening medium in the moistening medium chamber 431. As above, this pool of moistening medium acts as the supply of moistening medium 415, which is controlled by a float valve 407. A moistening medium filter 412 filters the moistening medium removed from the pool through fluid line 413 which connects to the nozzle 405. The fog generator 1′ is then supplied with the moistening medium in a self-contained manner.

The spray chamber 430 acts like an induction conduit, in that the geometry of the length and cross-sectional dimensions of the spray chamber as well as the spray angle α of the conical shaped spray F₁ is optimized to draw air F₄ through the air filter 404 and to induce the mixing of the clean air F₂ with the spray F₁. As with other described embodiments, the air filter may be connected to a supply of air, such as a fan or an air duct from a facility's current ventilation system. If such connection to a supply of air is the case, the geometry of the spray chamber as with the induction conduits described above becomes less important. The amount of air F₂, which can mix with the spray F₁, also dramatically increases.

The embodiment depicted in FIG. 6 operates in a similar manner as the embodiment shown in FIG. 5 with the exception that the supply of moistening medium 520 is an external source. The fog generator 1′ includes a suction housing 502 which forms a spray chamber 530. A nozzle 505, located on a wall 522 of the of the spray chamber 530, connects to an external supply of moistening medium 520, which the nozzle 505 disperses as droplets in the form of a conical spray F₁ with a spray angle α. Air F₄ entering through air filter 504 is cleaned and the spray F₁ induces clean air F₂ to mix with it to form a mist of clean air F₂ and droplets of moistening medium. Since, as above, the outlet conduit 508 is not located directly in front of the spray F₁, a simple moistening medium separator 506, the wall 521, causes the heavier droplets to accumulate and then flow out of the spray chamber 530 through drain 518 and thus out of the fog generator 1′. A pump may also be used to remove this excess moistening medium. As above, the heavier moistening medium droplets travel generally straight toward the wall 521 of the spray chamber 530, while clean air F₂ and the micro-droplets of the moistening medium travel out of the outlet conduit 508 in the form of a fine mist F₃.

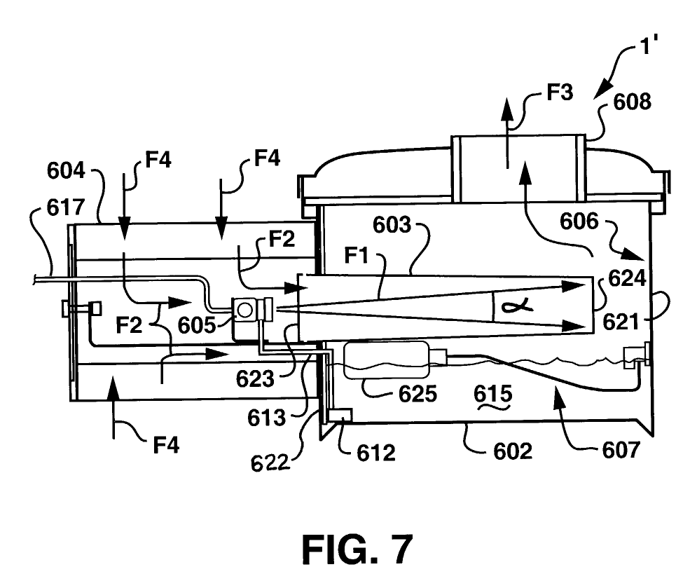

FIG. 7 shows another embodiment with a different construction of a fog generator 1′. The fog generator 1′ includes a suction housing 602 having an induction conduit 603 inserted horizontally through an opening formed by a side wall 622 of the suction housing 602 with one end 623 of the induction conduit 603 extending externally from the suction housing 602. A nozzle 605 is disposed to the external end 623 of the induction conduit 603. An air filter 604 surrounds the nozzle 605, enclosing both the nozzle 605 and the external end 623 of the induction conduit 603. A carrying medium from a supply of a carrying medium 617 and a moistening medium from a supply of a moistening medium 615 are fed to the nozzle 605. The nozzle 5 releases a spray F₁ of a mixture of the carrying medium and droplets of the moistening medium within an induction conduit 603. Air F₄ entering through air filter 604 is cleaned and the spray F₁ with a spray angle α induces clean air F₂ to mix with it to form a mist of clean air F₂ and droplets of moistening medium.

Since, as above, the outlet conduit 608 is not located directly in front of the spray F₁, a simple moistening medium separator 606, the wall 621, causes the heavier droplets exiting end 624 of the induction conduit 603 to accumulate and then flow into a pool of moistening medium in the suction housing 602 as the fine mist F₃ exits the outlet conduit 608. As above, this pool of moistening medium acts as the supply of moistening medium 615, which is controlled by a float valve 607 having a float 625. A moistening medium filter 612 filters the moistening medium removed from the pool through fluid line 613 which connects to the nozzle 605. The fog generator 1′ is then supplied with the moistening medium in a self-contained manner.

It will be appreciated by those skilled in the art that various modifications and variations can be made in the present invention without departing from the scope of the invention. It is intended that the present invention include such modifications and variations as come within the scope of the appended claims and their equivalents.

What is claimed:

1. A fog generator for creating a fine mist to moisten a product being processed, or an environment to be humidified, said fog generator comprising:
a suction housing;
an induction conduit carried within said suction housing, said induction conduit being open on opposite ends of said induction conduit;
a nozzle operably disposed at one of said open ends of said induction conduit and to both a supply of a moistening medium and a supply of a carrying medium, said nozzle creating a spray formed by mixing said supply of said carrying medium and said supply of said moistening medium;
a moistening medium separator operably disposed at an opposite open end of said induction conduit from said nozzle, said moistening medium separator causing excessively large droplets of said moistening medium to be removed from said mist; and
an outlet conduit integral to said suction housing, said outlet conduit releasing said mist from said fog generator.

2. A fog generator as in claim 1, further comprising an air filter operably disposed so as to clean air that enters into said fog generator, so that clean air is caused to mix with said spray to form said mist.

3. A fog generator as in claim 2, wherein said supply of said moistening medium includes a pool of said moistening medium deposited at the bottom of said suction housing.

4. A fog generator as in claim 3, wherein said supply of said moistening medium includes a moistening medium filter.

5. A fog generator as in claim 4, wherein said supply of said moistening medium includes a sensing device to control the amount of said moistening medium that is fed to said nozzle.

6. A fog generator as in claim 5, wherein said sensing device includes a moistening medium sensor and a solenoid.

7. A fog generator a sin claim 5, wherein said sensing device includes a float valve.

8. A fog generator as in claim 1, wherein said moistening medium separator includes a plate member disposed opposite from said induction conduit and having a size generally greater than said induction conduit.

9. A fog generator as in claim 1, wherein said moistening medium separator includes a container disposed to said induction conduit.

10. A fog generator as in claim 9, wherein said moistening medium separator includes a drain which transports any accumulation of said moistening medium to said pool.

11. A fog generator as in claim 1, wherein said nozzle creates a spray with a conical shape.

12. A fog generator as in claim 11, wherein said nozzle creates an spray angle between 10° and 45°.

13. A fog generator as in claim 12, wherein said spray angle is about 20°.

14. A fog generator as in claim 13, wherein the geometry of said spray angle and a length and cross-sectional dimensions of said induction conduit are used to maximize an induction of a flow of air into said induction conduit to mix with said spray.

15. A generator as in claim 1, further comprising a supply of air operably disposed to said suction housing.

16. A fog generator as in claim 15, wherein said supply of air is a fan.

17. A fog generator as in claim 15, wherein said supply of air is an air duct from an air conditioning system used within a facility in which said fog generator operates.

18. A fog generator as in claim 1, wherein said moistening medium separator is a wall of said suction housing.

19. A fog generator as in claim 3, wherein said moistening medium separator is said pool of said moistening medium.

20. A fog generator as in claim 1, wherein said moistening medium is water.

21. A fog generator as in claim 1, wherein said carrying medium is compressed air.

22. A fog generator as in claim 1, wherein said supply of said moistening medium is external to said suction housing and under pressure.

23. A fog generator as in claim 1, further comprising a drain operably disposed to said suction housing, said drain draining accumulated moistening medium which is separated from said fine mist.

24. A fog generator as in claim 1, further comprising a generated vacuum source operably disposed to said suction housing, said generated vacuum source draining accumulated moistening medium which is separated from said fine mist.

25. A fog generator as in claim 1, wherein said fine mist includes air and micro-droplets of said moistening medium.

26. A fog generator for creating a fine mist to moisten a product being processed, said fog generator comprising:
a suction housing;
a nozzle operably disposed within said suction housing and to a supply of a moistening medium, said nozzle creating a spray of said moistening medium;
a moistening medium separator operably disposed within said suction housing opposite said nozzle, said moistening medium separator causing excessively large droplets of said moistening medium to be removed from said mist; and
an outlet conduit integral to said suction housing, said outlet conduit releasing said mist from said fog generator.

27. A fog generator as in claim 26, further comprising an air filter operably disposed so as to clean air that enters into said fog generator, so that clean air is caused to mix with said spray to form said mist.

28. A fog generator as in claim 26, further comprising a drain operably disposed to said suction housing, said drain draining accumulated moistening medium which is separated from said mist.

29. A fog generator as in claim 26, further comprising a generated vacuum source operably disposed to said suction housing, said generated vacuum source draining accumulated moistening medium which is separated from said mist.

30. A fog generator as in claim 26, wherein said supply of said moistening medium is external to said suction housing.

31. A fog generator as in claim 30, wherein said supply of said moistening medium is supplied under pressure.

32. A fog generator as in claim 31, further comprising an induction conduit carried within said suction housing, said induction conduit being open on opposite ends of said induction conduit.

33. A fog generator as in claim 32, wherein said nozzle is operably disposed at one of said open ends of said induction conduit.

34. A fog generator as in claim 32, wherein said moistening medium separator is operably disposed at an opposite open end of said induction conduit from said nozzle.

35. A fog generator as in claim 34, wherein said moistening medium separator includes a plate member disposed opposite from said induction conduit and having a size generally greater than said induction conduit.

36. A fog generator as in claim 26, wherein said moistening medium separator includes a container disposed to said induction conduit.

37. A fog generator as in claim 36, wherein said moistening medium separator includes a drain connected to said container which transports any accumulation of said moistening medium to said pool.

38. A fog generator as in claim 27, further comprising a spray chamber disposed within said suction housing, said spray chamber having said air filter, said outlet conduit, said moistening medium separator, and said nozzle disposed thereto.

39. A fog generator as in claim 38, wherein said nozzle creates a spray with a conical shape.

40. A fog generator as in claim 39, wherein said nozzle creates an angle of spray between 10° and 45°.

41. A fog generator as in claim 40, wherein the geometry of said spray angle, positioning of said nozzle in relation to the length of said spray chamber, and cross-sectional dimensions of said spray chamber are used to maximize an induction of a flow of said air into said spray chamber to mix with said spray.

42. A fog generator as in claim 40, wherein said angle of spray is about 20°.

43. A fog generator as in claim 26, further comprising a supply of air operably disposed to said suction housing.

44. A fog generator as in claim 43, wherein said supply of air is a fan.

45. A fog generator as in claim 43, wherein said supply of air is an air duct from an air conditioning system used within a facility in which said fog generator operates.

46. A fog generator as in claim 26, wherein said moistening medium separator is a wall of said suction housing.

47. A fog generator as in claim 26, wherein said moistening medium is water.

48. A fog generator as in claim 38, further comprising a supply of carrying medium connected to a nozzle, said supply of carrying medium feeding a carrying medium to said nozzle.

49. A fog generator as in claim 48, wherein said carrying medium is compressed air.

50. A fog generator for creating a fine mist to moisten a product being processed, or an environment to be humidified, said fog generator comprising:
a suction housing;
an induction conduit operably disposed to said suction housing, said induction conduit being open on opposite ends of said induction conduit;
a nozzle operably disposed at one of said open ends of said induction conduit and to a supply of a moistening medium, said nozzle creating a spray of said moistening medium;
an air filter operably disposed to said suction housing, said air filter cleaning air that enters into said fog generator, so that clean air is caused to mix with said spray to form said mist;
a moistening medium separator operably disposed at an opposite open end of said induction conduit from said nozzle, said moistening medium separator causing excessively large droplets of said moistening medium to be removed from said mist; and
an outlet conduit integral to said suction housing, said outlet conduit releasing said mist from said fog generator.

51. A fog generator as in claim 50, wherein said nozzle is externally disposed to said suction housing.

52. A fog generator as in claim 50, wherein said supply of said moistening medium includes a pool of said moistening medium deposited at the bottom of said suction housing.

53. A fog generator as in claim 50, wherein said nozzle creates a spray with a conical shape.

54. A fog generator as in claim 53, wherein said nozzle creates an spray angle between about 10° and 45°.

55. A fog generator as in claim 54, wherein said spray angle is about 20°.

56. A fog generator as in claim 50, further comprising a drain operably disposed to said suction housing, said drain draining accumulated moistening medium which is separated from said mist.

57. A fog generator as in claim 50, further comprising a generated vacuum source operably disposed to said suction housing, said generated vacuum source draining accumulated moistening medium which is separated from said mist.

58. A fog generator as in claim 50, further comprising a supply of carrying medium connected to a nozzle, said supply of carrying medium feeding a carrying medium to said nozzle.

59. A fog generator as in claim 58, wherein said carrying medium is compressed air.

60. A fog generator as in claim 50, wherein said supply of said moistening medium is supplied under pressure.
